(19) United States
(12) Patent Application Publication
(10) Pub. No.: US 2011/0081113 A1
(43) Pub. Date: Apr. 7, 2011

(54) Fiber Optic Connector Assembly and Methods Therefor

(76) Inventor: Ashley W. Jones, Denton, TX (US)

(21) Appl. No.: 12/862,882

(22) Filed: Aug. 25, 2010

Related U.S. Application Data
(60) Provisional application No. 61/248,116, filed on Oct. 2, 2009.

(51) Int. Cl. G02B 6/38

(52) U.S. Cl. 385/62

(57) ABSTRACT

A fiber optic connector assembly includes two connectors on fiber optic cables joined together by a clip having a trigger arm and a clip body. The trigger arm extends from the clip body at a shallow angle. The shallow angle of the trigger arm effectively reduces an amount of normal force required to activate latch mechanisms on the connectors. The clip is sandwiched between a connector housing and a boot, inhibiting the clip from axially translating relative to the connector assembly. The clip further includes an anti-rotation system to inhibit rotation of the connector assembly relative to the clip.

### CROSS-REFERENCE TO RELATED APPLICATIONS

This application claims the benefit of U.S. Provisional Application No. 61/248,116, filed Oct. 2, 2009.

### BACKGROUND

1. Technical Field

A fiber optic connector assembly is disclosed and methods therefor. In particular, a fiber optic clip is disclosed that combines two fiber optic connectors on fiber optic cable into a duplex fiber optic connector assembly and methods therefor.

2. Technical Background

Fiber optic networks typically use dedicated input and output channels, usually called ports, each input and output channel having a single optical fiber in a connector assembly. High density environments require that many ports be arranged into arrays, usually in rack mounted hardware. For better organization, input and output channels are grouped together in pairs with one pair representing one port. However, high density environments make installing and removing such dedicated pairs difficult. What is needed is a clip that secures pairs of connectors together and maintains predetermined lateral and axial alignment for the dedicated pairs while easing installation and removal tasks.

### SUMMARY

A fiber optic connector assembly includes at least one fiber optic cable and at least one connector attached to the at least one fiber optic cable. The connector includes a housing and a boot attached to the housing and about the at least one fiber optic cable, and a clip to join the at least one fiber optic connector assembly to another fiber optic connector assembly. The clip can be sandwiched between the housing and the boot. Accordingly, the clip is substantially inhibited from axially translating relative to the connector assembly.

The clip has a clip body extending between a front and a rear, having at least one receiving area and at least one receiving axis, the receiving area configured to receive at least a portion of the at least one connector. The clip can include a trigger arm, the trigger arm extending from the clip body to a distal end, the trigger arm being attached to the clip body in at least two attachment locations and including at least one cavity at the distal end. The trigger arm extends from the clip body at a shallow angle, the shallow angle being from about 20 degrees to about 30 degrees.

The cavity can be configured to interact with at least a portion of the housing to substantially inhibit the connector from rotating relative to the clip. Additionally, the clip includes at least one bolster, the bolster including a generally elongated protrusion extending from the front and substantially adjacent to the receiving area, and configured to interact with at least a portion of the housing to substantially inhibit the connector assembly from rotating relative to the clip. The cavity and the bolster form at least part of an anti-rotation system. The anti-rotation system substantially limits rotation of the connector assemblies relative to the clip, from about 0.0 degrees to about 2.0 degrees.

Additional features are set forth in the detailed description which follows, and in part will be readily apparent to those skilled in the art from that description or recognized by practicing the described embodiments and the claims, as well as the appended drawings.

It is to be understood that both the general description and the detailed description are exemplary, and are intended to provide an overview or framework to understand the claims. The accompanying drawings are included to provide a further understanding, and are incorporated in and constitute a part of this specification. The drawings illustrate one or more embodiment(s), and together with the description serve to explain principles and operation of the embodiments.

### BRIEF DESCRIPTION OF THE DRAWINGS

FIG. 1 is a perspective view of a fiber optic cable assembly and a clip;

FIG. 2 is a front perspective view of the clip;

FIG. 3 is a rear perspective view of the clip;

FIG. 4 is a rear elevation of the clip;

FIG. 5 is a cross sectional view of the clip of FIG. 4;

FIG. 6 is another cross sectional view of the clip of FIG. 4;

FIG. 7 is a perspective view of an alternate clip;

FIG. 8 is a perspective assembly view of the fiber optic cable assembly and the clip of FIG. 1;

FIG. 9 is a further perspective assembly view of the fiber optic cable assembly and the clip of FIG. 1;

FIG. 10 is a perspective view of a duplex fiber optic connector assembly; and

FIG. 11 is part of a cross sectional view of the duplex connector assembly of FIG. 10.

### DETAILED DESCRIPTION

Reference is now made in detail to the present preferred embodiments of the disclosure, examples of which are illustrated in the accompanying drawings. Whenever possible, identical or similar reference numerals are used throughout the drawings to refer to identical or similar parts. It should be understood that the embodiments disclosed herein are merely examples with each one incorporating certain benefits of the present disclosure. Various modifications and alterations may be made to the following examples within the scope of the present disclosure, and aspects of the different examples may be mixed in different ways to achieve yet further examples. Accordingly, the true scope of the disclosure is to be understood from the entirety of the present disclosure in view of, but not limited to the embodiments described herein.

A multi-connector assembly, for example, a duplex fiber optic connector assembly, is disclosed having two fiber optic connectors on a fiber optic cable joined together by a clip. The clip retains both connectors axially and laterally while preventing rotation of the connector relative to the clip. The clip has features to enable actuation of a latch on the connector to remove the connector from, for example, a connector adapter. The clip is installed on the two connectors by sliding the clip axially along the cable. Various embodiments will be further clarified by the following examples.

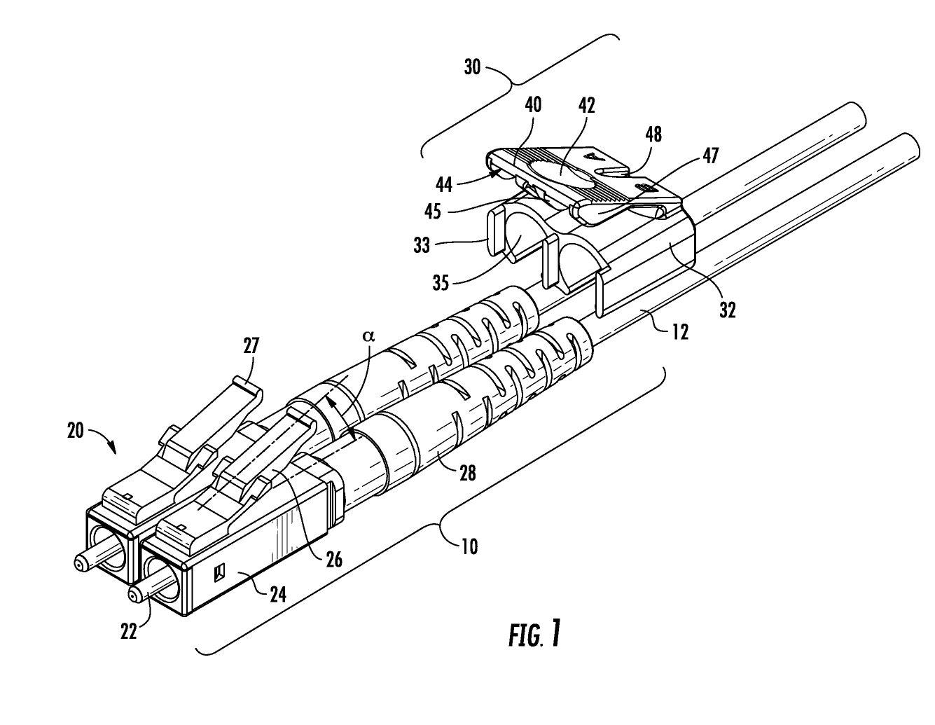

Fiber optic connector assembly 10 (FIG. 1) includes at least one fiber optic cable 12, at least one fiber optic connector 20 attached to cable 12, and at least one boot 28 for strain relief about connector 20 and cable 12. Connector 20 may be, for example, an LC connector. Connector 20 includes at least one optical ferrule 22, a connector housing 24 and at least one latch arm 26 extending at an angle α from connector housing 24 to an engagement end 27. As illustrated, connector 20 may include, but is not limited to, two connectors 20 attached to two cables 12, each having boot 28 about cable 12 and connector 20.

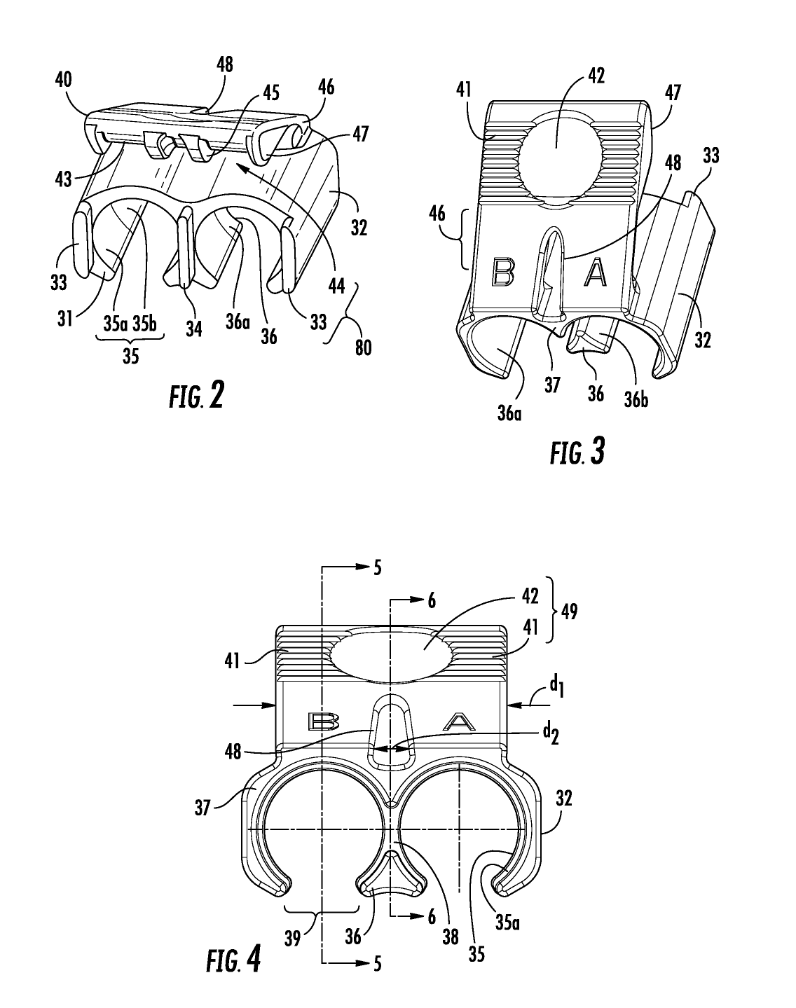

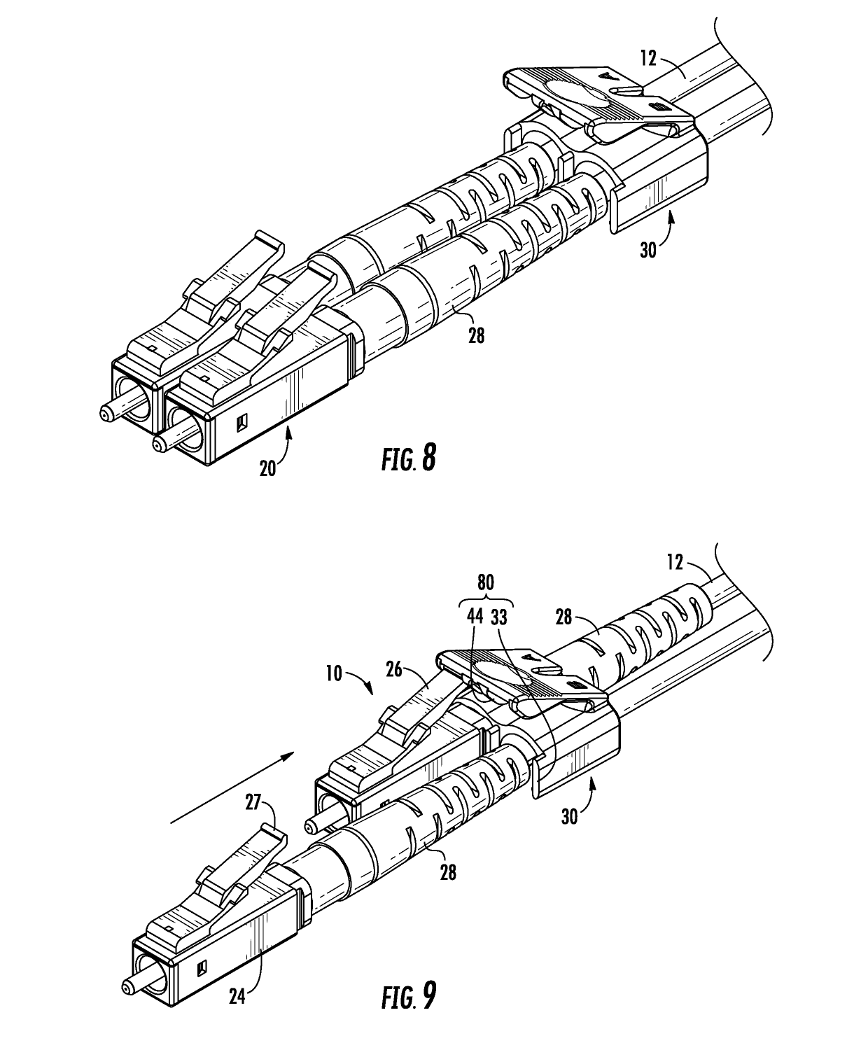

A clip 30, 50 (FIGS. 1-7), shown above cables 12, includes a clip body 32, 52 extending from a front 31, 51 to a rear 37, 57 defining a body length d5 (FIG. 6). At least one outer bolster 33, 53 and at least one inner bolster 34, 54 may extend from front 31, 51. Outer bolster 33, 53 and inner bolster 34, 54 may be elongated protrusions generally parallel to each other. Inner bolster 34 of clip 30 may be narrower than inner bolster 54 of clip 50. Clip body 32, 52 includes at least one connector assembly receiving area 35, 55 about at least one receiving axis, for example, a longitudinal axis. Receiving area 35, 55 includes at least one first friction surface 35a, 55a and at least one second friction surface 35b, 55b. Receiving area 35, 55 may include, for example, at least a pair of receiving areas 35, 55, each receiving area 35, 55 including at least a pair of longitudinal axes that are, in exemplary embodiments, substantially parallel to each other. In an exemplary embodiment, a distance, or pitch, between the longitudinal axes is about 5.25 mm (FIG. 2). In an alternate embodiment (FIG. 7) the pitch between the longitudinal axes is about 6.25 mm. Friction surfaces 35a, 55a and 35b, 55b may be inner radial surfaces, each defining a different radius, that substantially share, for example, a common longitudinal axis. In an exemplary embodiment, friction surface 35a, 55a defines a generally smaller radius than does friction surface 35b, 55b. Friction surfaces 35a, 55a and 35b, 55b may be separated by a planar surface 38, 58 that is generally orthogonal relative to friction surfaces 35a, 55a and 35b, 55b. At least one cable opening 39, 59 may be a lateral opening that extends from front 31, 51 to rear 37, 57 adjacent to receiving area 35, 55. In exemplary embodiments, clip 30, 50 includes at least two cable opening 39, 59 opposite a trigger arm 40. Clip 30, 50 may be made from a thermoplastic material, for example, a polycarbonate, and in exemplary embodiments is made from a substantially flame retardant polycarbonate such as LEXAN™ 940, available from Saudi Basic Industries Corporation (SABIC) Innovative Plastics, Houston, Tex. However, other suitable materials may also be used.

In an embodiment, a spur 36 (FIGS. 2-6) extends from planar surface 38, defining a spur length d6 (see FIG. 6), and in exemplary embodiments does not extend as far as rear 37. In other exemplary embodiments, spur length d6 is about 2.1 mm and ends about 1.7 mm from rear 37. Spur 36 includes at least two complementary spur surfaces 36a and 36b. Spur surfaces 36a and 36b may be inner radial surfaces that define a radius substantially the same as at least one of the radii for friction surfaces 35a and 35b. Spur surfaces 36a and 36b substantially share an axis with at least one of friction surfaces 35a and 35b, for example, one of longitudinal axes of receiving area 35, 55. In exemplary embodiments, spur surfaces 36a and 36b define a radius substantially equal to the radius of friction surface 35b and substantially share an axis with friction surface 35b.

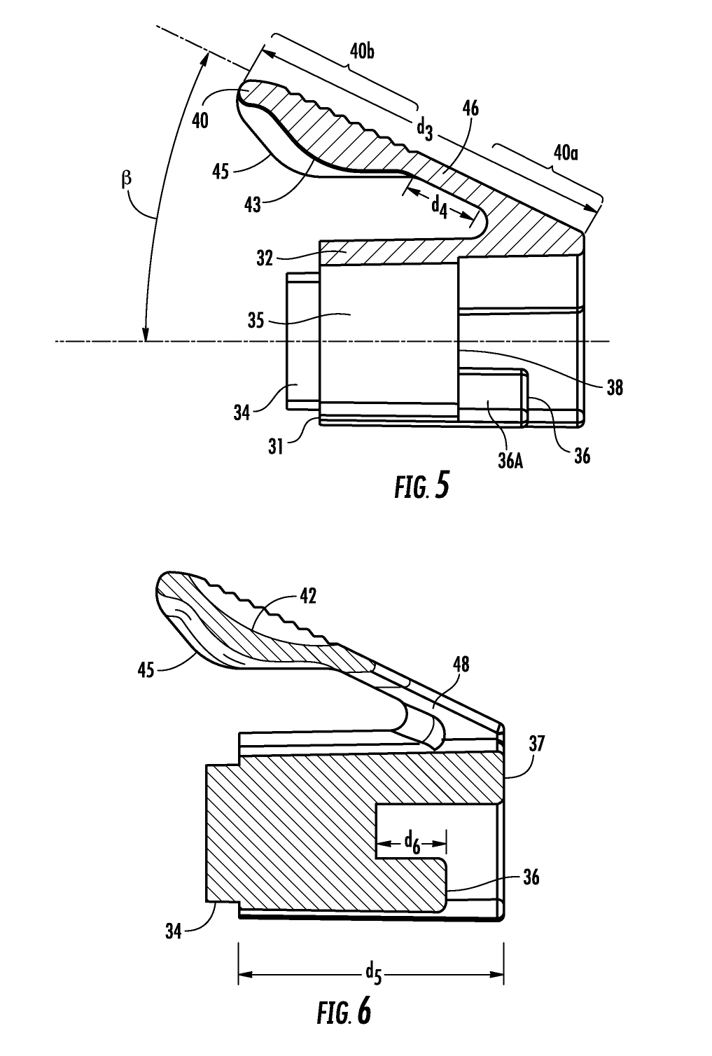

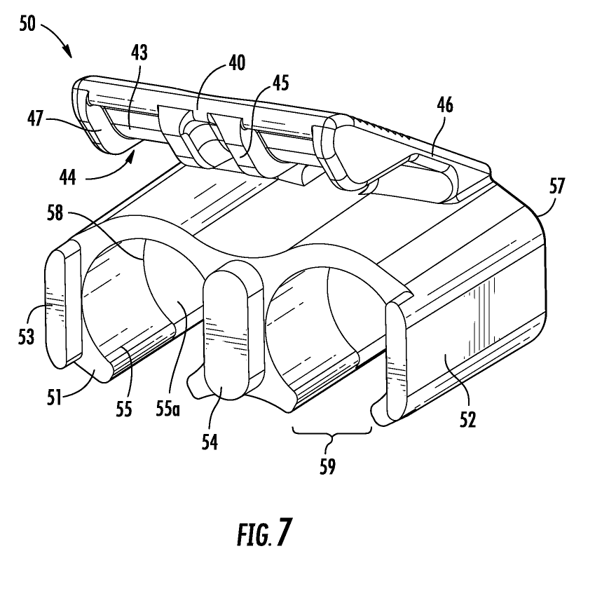

Trigger arm 40 may be attached to clip body 32, 52 in at least two attachment locations. Trigger arm 40 extends from clip body 32, 52 to a distal end, defining an arm length d3 and an angle α (FIG. 5). Angle β may include a range of angles measured relative to, for example, the longitudinal axes. Angle α may be less than about 45 degrees. In exemplary embodiments, angle α is from about 20 degrees to about 30 degrees. In yet other exemplary embodiments, angle α is from about 24 degrees to about 27 degrees. Body length d5 and arm length d3 define a ratio, d3:d5, from about 1.4:1 to about 1.5:1. Trigger arm 40 includes at least one relatively flexible portion 46 defining a flexible length d4 along arm length d3, with flexible portion 46 located at a substantially medial location along trigger arm 40. Flexible portion 46 may be located between two rigid zones 40a, 40b that are substantially rigid relative to flexible portion 46. Flexible portion 46 may have a thickness substantially less than the thickness of rigid zones 40a, 40b. Arm length d3 and flexible length d4 define a flexible length ratio, d3:d4, from about 4:1 to about 6:1. In exemplary embodiments, flexible length ratio d3:d4 is about 5:1.

Trigger arm 40 further defines an arm width d1. A gap 48 defining a gap distance d2, may be located along arm width d1 and proximal to clip body 32. Arm width d1 and gap distance d2 define a gap ratio, d1:d2, from about 3:1 to about 13:1. In an exemplary embodiment, gap ratio d1:d2 is about 4:1. In yet another exemplary embodiment, gap ratio d1:d2 is about 12:1. Gap 48 may extend generally from clip body 32, 52 along trigger arm 40 to, for example, flexible portion 46; however, gap 48 may extend further than flexible portion 46 in alternate embodiments.

Trigger arm 40 defines a cavity 44 on the distal end including a depressor surface 43 having an inner lobe 45 and an outer lobe 47 on each side adjacent to depressor surface 43. Cavity 44 may cooperate with at least one of outer bolster 33, 53 or one of inner bolster 34, 54 to at least partially define an anti-rotation system 80. Cavity 44 may, in exemplary embodiments, cooperate with outer bolster 33, 53 and inner bolster 34, 54 to at least partially define the anti-rotation system 80. Trigger arm 40 further defines at least one hollow 42 adjacent to at least one notch 41. Hollow 42 may be, for example, located in a medial location along the arm width d1, adjacent to the distal end of trigger arm 40. Hollow 42 cooperates with notch 41 to define a trigger grip 49.

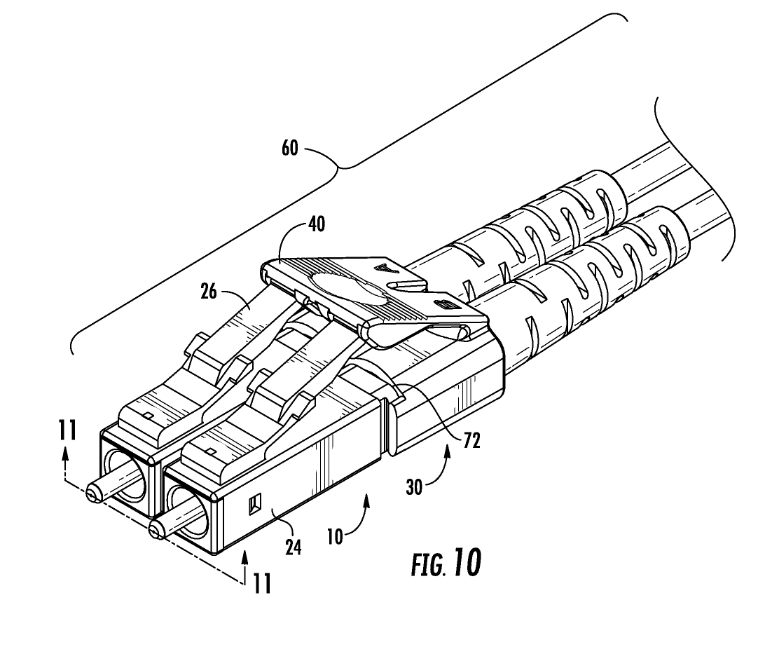

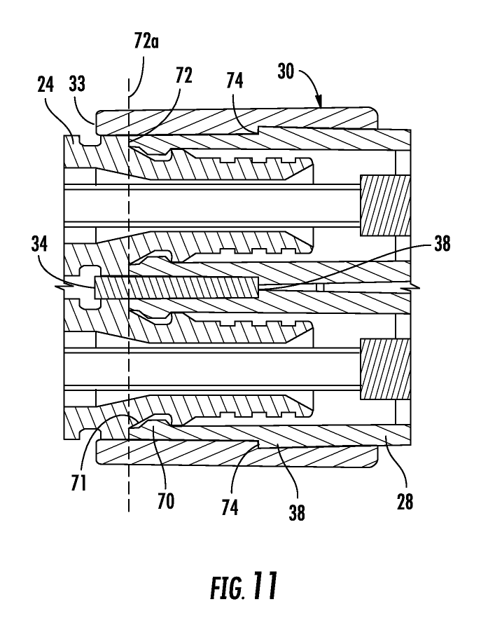

During an assembly, clip 30 (used in this example for clarity) may be moved onto cables 12, rearward of boots 28 (FIG. 8). Cable opening 39, in exemplary embodiments, is configured to laterally receive cable 12, such that receiving area 35 is substantially about cable 12. In other embodiments, cable opening 39 may be configured to laterally receive other cables. In an exemplary assembly, each of connector assemblies 10 may be moved individually in a rearward direction, pushing boot 28 within one of receiving areas 35, until a portion of housing 24 substantially abuts front 31 of clip 30 at a housing interface 72, and engagement end 27 is substantially cradled within one of cavities 44 (FIGS. 9 and 10). In an exemplary assembly, clip 30 may be moved relative to connector assemblies 10, pushing clip 30 in a forward direction about boots 28 until reaching housing interface 72. In yet another exemplary assembly, both connector assemblies 10 and clip 30 may be moved concurrently toward each other until clip 30 is about boots 28 and has reached housing interface 72. A duplex connector assembly 60 is made from the pair of connector assemblies 10 joined laterally by clip 30 (FIG. 10).

A partial cross sectional view of duplex connector assembly 60 shows the relationship of clip 30 to connector assemblies 10 (FIG. 11). A latch 70 on boot 28, which is made from such resilient material as, for example, a rubber, a urethane, or a silicone, etc., is engaged with a latch receiver 71 on housing 24. Boot 28 fits into receiving area 35 with an interference fit, substantially inhibiting latch 70 and latch receiver 71 from disengaging under an applied axial load. Boot 28 substantially abuts housing 24, defining an interface plane 72a that corresponds substantially to housing interface 72. Boot 28 is substantially inhibited from advancing in a forward direction, for example, toward ferrule 22, at about interface plane 72a. Clip 30 is substantially inhibited from advancing in a forward direction at about housing interface 72. A step 74 on boot 28 substantially abuts planar surface 38, substantially inhibiting clip 30 from retreating in rearward direction, for example, away from ferrule 22. Stated another way, once clip 30 is sandwiched between housing 24 and step 74, with boot 28 substantially inhibited from disengaging from housing 24, clip 30 is substantially inhibited from translating axially relative to any portion of connector assembly 10.

The retention of clip 30 on connector assembly 10 creates an intersection between engagement end 27 and cavity 44. In exemplary embodiments, engagement end 27 contacts depressor surface 43. As trigger arm 40 is deflected downward, latch arm 26 is also deflected downward, guided laterally by lobes 46 and 47. However, due to retention of clip 30 about connector assemblies 10, the relative positions of engagement end 27 and the distal end of trigger arm 40 changes during deflection, causing engagement end 27 to slide along depressor surface 43. Depressor surface 43 is configured to impart a cam-like action to engagement end 27 while actuating trigger arm 40. In other words, as trigger arm 40 is deflected by one distance, latch arm 26 is deflected by a progressively greater distance as engagement end 27 slides across depressor surface 43. The cam-like action reduces the overall effort and distance required to deflect trigger arm 40 sufficiently to achieve a desired deflection of latch arm 26, for example, deflected sufficiently to release duplex connector 60 from a miniature Small Form-factor Pluggable (Mini-SFP) transceiver or a duplex adapter.

Anti-rotation system 80 may include at least one of outer bolster 33, 53, at least one of inner bolster 34, 54 and at least one cavity 44. Housing 24 may be received between outer 33, 53 and inner 34, 54 bolsters and provide a substantially inflexible wall alongside housing 24. Engagement end 27 of latch arm 26 may be received between inner 45 and outer 47 lobes of cavity 44, providing substantially inflexible walls alongside latch arm 26. Anti-rotation system 80 substantially limits rotation of connector assembly 10 from about 0.0 degrees to about 2.0 degrees. In exemplary embodiments, anti-rotation system 80 substantially limits rotation of connector assembly 10 from about 0.5 degrees to about 1.5 degrees.

Angle β of trigger arm 40 may have a measurement of less than twice angle α. Decreasing angle β initiates the sliding of latch arm 26 along depressor surface 43 almost immediately upon deflection of trigger arm 40, with less effort than for other clips having triggers with angles greater than twice angle α of latch arm 26. Put another way, by sliding along depressor surface 43 earlier during the deflection of trigger arm 40, the rate of deflection of engagement end 27 relative to trigger arm 40 is accelerated earlier, requiring less effort. For example, in exemplary embodiments latch arm 26 has an angle α of about 15 degrees. In exemplary embodiments of clip 30, angle β is from about 24 degrees to about 27 degrees, which is less than twice α. By reducing angle β, the vertical force component of a normal force applied to trigger arm 40 is increased. In exemplary embodiments, at an angle β from about 24 degrees to about 27 degrees, an applied normal force to trigger arm 40 required to impart a required vertical force component at least sufficient to deflect latch arm 26 may be from about 20% to about 30% less than a normal force applied to a trigger having an angle of, for example, about 45 degrees or greater.

Gap 48 extending generally from clip body 32, 52 along trigger arm 40 into flexible portion 46 further reduces the normal force necessary to achieve the required vertical force component sufficient to deflect latch arm 26. The normal force required to deflect latch arm 26 is a combination of the required latch arm 46 normal force and the required trigger arm 40 normal force. Flexible portion 46 may be made further flexible by gap 48, further reducing the normal force required to deflect trigger arm 40. In other words, flexible portion 46 is made more flexible by the absence of material, as in gap 48, at a substantially medial location in flexible portion 46. Having the required normal force for trigger arm 40 lessened reduces the total amount of normal force necessary to deflect latch arm 26 by way of clip 30, 50.

In exemplary applications, multiple duplex connector assemblies 60 may be densely arranged into such arrays as are used in rack mounted hardware. Clip 30, 50, having arm length d3, provides improved linear access to release duplex connector 60 in situations when vertical access is difficult. In exemplary embodiments, duplex connector 60 may be released by reaching into the array and pushing on trigger grip 49 with, for example, a finger, while placing, for example, a thumb underneath duplex connector assembly 10 and squeezing to release latch arms 26. Trigger grip 49 may then be used to assist in pulling duplex connector 60 from the array.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosed fiber optic connector clip. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A fiber optic connector assembly, comprising:
at least one fiber optic cable;
at least one connector attached to the at least one fiber optic cable, the connector including:
a housing;
a boot about the at least one fiber optic cable and attached to the housing; and
a clip, the clip including a clip body extending between a front and a rear, the clip body including at least one receiving area having at least one receiving axis, the receiving area configured to receive at least a portion of the at least one connector, the clip further including a trigger arm, the trigger arm extending from the clip body to a distal end, the trigger arm being attached to the clip body in at least two attachment locations and including at least one cavity at the distal end, the cavity being configured to interact with at least a portion of the housing to substantially inhibit the connector from rotating relative to the clip.

2. The assembly of claim 1, the clip body including at least one bolster, the at least one bolster comprising a generally elongated protrusion extending from the front and substantially adjacent to the receiving area, the at least one bolster being configured to interact with at least a portion of the housing to substantially inhibit the connector assembly from rotating relative to the clip.

3. The assembly of claim 1, the clip including an anti-rotation system, the at least one bolster and the at least one cavity cooperating to define the anti-rotation system.

4. The assembly of claim 3, the anti-rotation system substantially limiting rotation of the at least one connector assembly from about 0.0 degrees to about 2.0 degrees.

5. The assembly of claim 3, the anti-rotation system substantially limiting rotation of the at least one connector assembly from about 0.5 degrees to about 1.5 degrees.

6. The assembly of claim 1, the trigger arm extending from the clip body at an angle relative to the at least one receiving axis from about 20 degrees to about 30 degrees.

7. The assembly of claim 8, the trigger arm extending from the clip body at an angle relative to the at least one receiving axis from about 24 degrees to about 27 degrees.

8. The assembly of claim 1, the trigger arm including at least one hollow and at least one notch, the at least one hollow located adjacent to the at least one notch.

9. The assembly of claim 8, the clip including a trigger grip, the trigger grip comprising the at least one hollow and the at least one notch.

10. The assembly of claim 1, the trigger arm having an arm width and a gap near the clip body along the arm width between the at least two attachment locations, the gap extending from the clip body to at least the flexible portion.

11. The assembly of claim 1, the receiving area having at least two friction surfaces in substantially axial alignment about the at least one receiving axis.

12. The assembly of claim 11, the receiving area including at least one planar surface, the at least one planar surface substantially separating the at least two friction surfaces.

13. The assembly of claim 1, the assembly including at least two connector assemblies, the clip body defining at least two receiving areas for receiving the at least two connector assemblies.

14. The clip of claim 1, the receiving area including at least one planar surface, the at least one planar surface configured to cooperate with at least a portion of the boot.

15. The clip of claim 14, the clip contacting a portion of the housing, the clip being sandwiched between the housing and the boot inhibiting the clip from axially translating relative to the fiber optic connector.

16. The clip of claim 14, the clip frictionally receiving a portion of the boot, the receiving area substantially inhibiting the boot from disengaging from the housing.

17. A clip for joining at least two fiber optic connectors, the clip comprising:
a clip body, the clip body extending between a front and a rear, the clip body including a receiving area having at least one receiving axis, and at least one bolster extending from the front, the receiving area configured for receiving the at least two fiber optic connectors;
a trigger arm, the trigger arm being attached to the clip body at least two attachment locations with a gap therebetween, the trigger arm extending from the clip body to a distal end and including a trigger grip, the trigger grip including at least one hollow and at least one notch adjacent to the hollow, and a cavity, the cavity including at least one lobe and at least one depressor surface adjacent to the at least one lobe; and
an anti-rotation system, the anti-rotation system including the at least one bolster.

18. The clip of claim 17, the anti-rotation system further including the at least one cavity.

19. The assembly of claim 18, the anti-rotation system substantially limiting rotation of each of the at least two connector assemblies from about 0.0 degrees to about 2.0 degrees.

20. The assembly of claim 19, the anti-rotation system substantially limiting rotation of each of the at least two connector assemblies from about 0.5 degrees to about 1.5 degrees.
